(19) United States
(12) Patent Application Publication
(10) Pub. No.: US 2021/0380117 A1
(43) Pub. Date: Dec. 9, 2021

(54) Method and Control Unit for Adapting an at Least Partially Autonomous Vehicle to a User

(71) Applicant: Bayerische Motoren Werke Aktiengesellschaft, Muenchen (DE)

(72) Inventor: Orland GONZALEZ, Muenchen (DE)

(21) Appl. No.: 17/284,012

(22) PCT Filed: Oct. 23, 2019
(86) PCT No.: PCT/EP2019/078804

§ 371 Date: Apr. 9, 2021

(30) Foreign Application Priority Data
Oct. 26, 2018 (DE) 10 2018 126 834.3

(51) Int. Cl. B60W 40/09; B60W 30/12; B60W 30/16; B60W 50/08

(52) U.S. Cl. CPC B60W 40/09; B60W 30/12; B60W 2040/0818; B60W 50/085; B60W 30/16

(57) ABSTRACT

An apparatus includes a control unit for a vehicle that is equipped to cause automatic interventions in the longitudinal and/or lateral control of the vehicle. The control unit is configured to determine reaction information relating to a reaction of a user of the vehicle to at least one automatic intervention of the vehicle. The control unit is also configured to adjust least one operating parameter of the vehicle, which has an influence on automatic interventions in the longitudinal and/or lateral control of the vehicle, depending on the reaction information.

### BACKGROUND AND SUMMARY OF THE INVENTION

The embodiments of the invention relate to an at least partially autonomous vehicle. In particular, the embodiments of the invention also relate to a method and a corresponding control unit for setting an operating parameter of an autonomous or partially autonomous vehicle.

A vehicle that is at least partially autonomous has a certain driving behavior that is influenced by one or more operating parameters. For example, the driving behavior of the vehicle in the context of the automated longitudinal control of the vehicle is influenced by the dynamics of automatic interventions for longitudinal acceleration and/or for deceleration of the vehicle. In a corresponding way, the dynamics of automatic interventions in the lateral control of the vehicle have an influence on the driving behavior of the vehicle in the context of the automated lateral control.

Different users of a vehicle typically have different preferences in terms of the driving behavior of a vehicle. In particular, different users typically perceive an automatic intervention in the longitudinal and/or lateral control of a vehicle in different ways. This may result in automatic intervention in the longitudinal and/or lateral control of the vehicle and/or the driving style of the vehicle (for example a longitudinal distance to a vehicle ahead maintained by the vehicle) being perceived as unpleasant and/or unsettling for at least some of the users of a vehicle.

This document deals with the technical object of increasing the comfort and, in particular, the feeling of safety of users of a vehicle that is at least partially autonomous in an efficient and reliable manner. In this context, the vehicle may be designed to automatically adjust the driving style thereof to increase a sense of comfort and/or safety of a user.

This and other objects are achieved in each case by the inventive apparatus and method disclosed herein. It is pointed out that additional features of a claim which is dependent on an independent claim without the features of the independent claim or only in combination with a subset of the features of the independent claim, may form a separate invention which is independent of the combination of all the features of the independent claim, and which can be made the subject matter of an independent claim, a partial application, or a subsequent application. This applies in the same way to technical teachings described in the description, which may form an invention independent of the features of the independent claims.

According to one aspect, a control unit for a vehicle is described. The vehicle is set up to cause automatic interventions in the longitudinal and/or lateral control of the vehicle. For this purpose, the vehicle may have one or more longitudinal and/or lateral control actuators, which can be operated automatically to automatically control the vehicle longitudinally and/or laterally. Examples of actuators are a drive motor, a braking device and/or a (electrical) steering system or steering device. The control unit may be set up to control the vehicle at least partially autonomously and possibly highly or fully autonomously by controlling one or more longitudinal and/or lateral control actuators of the vehicle.

The control unit is set up to determine reaction information relating to the reaction of a user (in particular the driver) of the vehicle to at least one automatic intervention of the vehicle. In other words, reaction information can be determined which indicates how satisfied the vehicle user is with the vehicle's automated driving style. In other words, reaction information can be determined which indicates the effect that the automated driving of the vehicle style has on the user. The reaction information can be provided on the basis of the behavior of the user during the at least partially autonomous driving of the vehicle. Typically, the reaction information does not depend on the input of the user via a user interface (such as an infotainment system) of the vehicle. In particular, the reaction information typically does not depend on an explicit selection or input of the user in a selection menu of a user interface of the vehicle and/or on the operation of a user interface of the vehicle (such as a driving mode switch of the vehicle). On the other hand, the reaction information may depend on the operation of the user of one or more control means for the longitudinal and/or lateral control of the vehicle (for example the operation of an accelerator pedal, a brake pedal and/or a steering wheel).

In addition, the control unit is set up to adapt at least one operating parameter of the vehicle, which has an influence on the automatic intervention in the longitudinal and/or lateral control of the vehicle (i.e. which has an influence on the at least partially autonomous driving of the vehicle), depending on the reaction information. At least one operating parameter can be adjusted in such a way that the actual reaction of the user indicated by the reaction information is changed to a target reaction. For example, the reaction information as an actual reaction can indicate a certain actual level of stress or uncertainty of the user. The target reaction can include a specific target level of stress or uncertainty. A change of the automated driving style of the vehicle can then be caused automatically by changing the value of at least one operating parameter of the vehicle, so that in the future the target reaction by the user is caused in the event of one or more automatic interventions. In this way, a vehicle that is at least partially autonomous can be adapted to a user in an efficient and reliable manner. This can increase the comfort and feeling of safety of a user in an autonomous vehicle.

The control unit may be set up to determine sensor data relating to the user of the vehicle (for example by means of one or more occupant sensors of the vehicle). The sensor data may indicate the head and/or face of the user and/or a body-related measurement variable (for example the pulse rate and/or the blood pressure) of the user. The reaction information can then be determined in relation to the user of the vehicle on the basis of the sensor data.

For example, it is possible to determine on the basis of the sensor data

a preferred direction of view of the user during the at least partially autonomous driving;

a facial expression of the user during the at least partially autonomous driving; and/or

a pulse rate and/or blood pressure of the user during the at least partially autonomous driving.

Based on the sensor data, for example an actual level of stress and/or uncertainty (as an actual reaction) of the user may be concluded. Furthermore, a target level of stress and/or uncertainty (as a target reaction) of the user may be defined. The actual reaction of the user can then be compared with the target reaction of the user. The at least one operating parameter can then be adjusted depending on the difference between the actual reaction and the target reaction in order to cause the user to have the target reaction during the at least partially autonomous driving.

The vehicle may comprise one or more control means (for example a brake pedal, an accelerator pedal and/or a steering device, such as a steering wheel), which enable the user to actuate the vehicle's longitudinal and/or lateral control by operating the control means. If necessary, the user may also be able to intervene manually in the longitudinal and/or lateral control of the vehicle during the at least partially autonomous driving of the vehicle, for example to correct the automated driving behavior of the vehicle.

The control unit may be set up to detect an operation of the control means which changes the effect on the vehicle of an automatic intervention of the vehicle. In other words, it can be detected that the user of the vehicle uses a vehicle control means to manually change the driving style of the vehicle. Examples of changes in the effect on the vehicle which can be caused by operating a control device, are: a change in the distance between the vehicle and another road user; a change of a time of intervention (for example braking) in the lateral and/or longitudinal control of the vehicle; a change in the longitudinal acceleration and/or deceleration of the vehicle; a change in the steering angle and/or the torque on the steering system of the vehicle; a change in the dynamics of the vehicle in the event of a (automatically initiated) lane change; and/or a cancellation of a (automatically initiated) lane change.

The reaction information can then indicate the change in the effect on the vehicle caused by the operation of the control means. In particular, the reaction information may indicate how the effects of an automatically performed intervention are or were corrected or altered manually by the user of the vehicle. The change in the effect caused by the user can be taken as an indication of the automatic intervention which the user of the vehicle would have preferred. In other words, the change in the effect caused by the user can be used as an indication of a target form of the automatic intervention (whereas the automatic intervention performed by the vehicle has a different actual form). The at least one operating parameter can then be adjusted in such a way that the automatic intervention has the target form.

The change in the effect caused by the user by operating a control means can be regarded as an actual reaction of the user (wherein the actual reaction is indicated by the reaction information). The target reaction of the user may be that the user does not cause any change in the effect of an automatic intervention (and therefore the operation of a control means need not take place). The at least one operating parameter can thus be adjusted in such a way that the reaction information indicates the target reaction in the event of a future automatic intervention.

By taking sensor data into account relating to the user and/or detected operations of a control means of the vehicle, an actual reaction of the user can be determined in a precise manner. In particular, it can be determined precisely whether the user is satisfied with the automated driving style of the vehicle or not, or whether the user has a relatively low level of stress or not. The precise determination of the actual reaction in turn enables precise automatic adjustment of the automated driving style of a vehicle in order to cause the user to have a specific target reaction (for example that the user has a certain level of stress and/or that the user does not essentially carry out corrective operations of a control means). In this way, the comfort and feeling of safety of a user in an at least partly autonomous (especially in a highly or fully autonomous) vehicle can be increased.

The control unit may be set up, on the basis of the reaction information, to determine that one or more automatic interventions of the automatic longitudinal and/or lateral control of the vehicle caused stress and/or uncertainty to the user. This can be determined in relation to the user on the basis of the sensor data. The value of at least one operating parameter of the vehicle can then be changed to reduce the dynamics of the automatic longitudinal and/or lateral control of the vehicle and/or to increase one or more safety distances to be observed during the automatic longitudinal and/or lateral control of the vehicle. In this way, the level of stress and/or uncertainty of a user can be reduced in a reliable manner (for example to a target level).

In a corresponding manner, the control unit may be set up to determine, on the basis of the reaction information, that an automatic longitudinal and/or lateral control of the vehicle caused by one or more automatic interventions of the vehicle does not cause stress and/or uncertainty to the user (or causes too low a level of level of stress and/or uncertainty). For example, it can be determined that the user perceives the driving style of the vehicle as monotonous.

The value of at least one operating parameter of the vehicle can then be changed to increase the dynamics of the automatic longitudinal and/or lateral control of the vehicle and/or to reduce one or more safety distances to be observed during the automatic longitudinal and/or lateral control of the vehicle. This can increase the stress and/or uncertainty level of a user (to a target level), which can also lead to an increase in the comfort of a user (as typically driving with increased dynamics and/or reduced safety distances reduces the total duration of a trip).

The at least one operating parameter may include: a minimum permissible safety distance of the vehicle from another road user; a maximum permissible driving speed of the vehicle; a recommended speed of the vehicle to be driven on average by the vehicle; a maximum permissible longitudinal acceleration and/or deceleration of the vehicle; a maximum permissible lateral acceleration of the vehicle; a maximum permissible steering torque and/or a maximum permissible steering angle on a steering wheel of the vehicle; a maximum permissible rate of change or a maximum permissible time gradient of the steering torque and/or of the steering angle on the steering system of the vehicle; a tendency of the vehicle to perform automatic lane changes on a multi-lane road; and/or dynamics when performing a lane change. The values of one or more operating parameters can be changed by a change in the control of one or more longitudinal and/or lateral control actuators of the vehicle. Thanks to the above operating parameters, the driving behavior of a vehicle that is at least partially autonomous can be precisely adapted to the preferences of a user.

The control unit may be set up to determine a corresponding plurality of user-specific values for at least one operating parameter for a plurality of different users of the vehicle and to store them in a corresponding plurality of user profiles. This can be done, for example, for different journeys of the vehicle with different users.

The user can then be determined for a specific journey of the vehicle from the plurality of different users who use the vehicle for the particular journey. Furthermore, during the specified journey of the vehicle, automatic intervention in the longitudinal and/or lateral control of the vehicle can be caused according to the user profile of the identified user. In this way, the driving behavior of the vehicle can be adapted to different users in an efficient and reliable manner.

The control unit may be set up to determine a driving behavior preferred by the user on the basis of the reaction information. In other words, it can be determined on the basis of the reaction information how the vehicle should behave in a particular driving situation according to the wishes of the user. The driving behavior preferred by the user may, for example, indicate a lane preferred by the user in a construction site area. Alternatively or in addition, the driving behavior preferred by the user may indicate that the user is reluctant to drive alongside a truck or bus in heavy traffic. The preferred driving behavior may be determined based on the fact that the user has a relatively high stress level and/or has a certain viewing direction and/or causes a manual operation of a control means in a corresponding driving situation.

The control unit can then be set up to cause automatic interventions in the longitudinal and/or lateral control of the vehicle in order to implement the user-preferred driving behavior. In this way, a user's comfort and/or feeling of safety can be further enhanced.

The control unit can be set up to repeatedly (for example periodically) determine reaction information and to adjust the values of one or more operating parameters repeatedly (for example periodically). In this way, an optimal adjustment of the automatic driving style of a vehicle for a user can be achieved in an iterative manner.

According to a further aspect, a method of adapting a vehicle to a user of the vehicle is described, wherein the vehicle is set up to cause automatic intervention in the longitudinal and/or lateral control of the vehicle. The method includes the determination of reaction information relating to a reaction of a user of the vehicle to the at least one automatic intervention of the vehicle. In addition, the method involves adjusting at least one operating parameter of the vehicle which has an influence on automatic interventions in the longitudinal and/or lateral control of the vehicle, depending on the reaction information.

According to a further aspect a (road) motor vehicle (in particular a passenger car or a truck or a bus) is described which comprises the control unit described in this document.

According to a further aspect a software (SW) program is described. The SW program can be set up to be run on a processor (for example on a control unit of a vehicle) and thus to perform the method described in this document.

According to a further aspect a storage medium is described. The storage medium may include a SW program, which is set up to be run on a processor and thereby to perform the method described in this document.

It should be noted that the methods, devices, and systems described in this document can be used both alone and in combination with other methods, devices and systems described in this document. Furthermore, any aspect of the methods, devices and systems described in this document can be combined in many ways. In particular, the features of the requirements can be combined in a variety of ways.

The aspects described in this document relate to a vehicle that is driven least partially autonomously. In the document, the term “autonomous driving” may include driving with automated longitudinal or lateral control or autonomous driving with automated longitudinal and lateral control. Autonomous driving may be, for example, longer term driving on the motorway or temporary driving as part of parking or maneuvering. The term “automated driving” includes automated driving with any degree of automation. Examples of degrees of automation are assisted, semi-automated, highly automated, or fully automated driving. These levels of automation have been defined by the Federal Institute for Road Transport (BASt) (see BASt publication “Research Compact”, issue November 2012). When driving in an assisted way, the driver carries out the longitudinal or lateral control continuously, while the system performs each other function within certain limits. In the case of semi-automated driving (TAF), the system takes over the longitudinal and lateral control for a certain period of time and/or in specific situations, wherein the driver must permanently monitor the system as in assisted driving. With highly automated driving (HAF), the system takes over the longitudinal and lateral control for a certain period of time without the driver having to monitor on a continuous basis; however, the driver must be able to take over the vehicle control in a certain time. With fully automated driving (VAF), the system can automatically handle driving in all situations for a specific use case; for this use case, there is no longer a need for a driver. The above four levels of automation correspond to SAE levels 1 to 4 of SAE J3016 (SAE—Society of Automotive Engineering). For example, highly automated driving (HAF) level 3 complies with the SAE J3016 standard. In addition, SAE J3016 also provides for SAE level 5 as the highest degree of automation, which is not included in the BASt definition. SAE level 5 is equivalent to driverless driving, where the system can automatically handle all situations like a human driver throughout the journey; a driver is generally no longer required.

Other objects, advantages and novel features of the embodiments of the present invention will become apparent from the following detailed description of one or more preferred embodiments when considered in conjunction with the accompanying drawings.

### BRIEF DESCRIPTION OF THE DRAWINGS

FIG. 1 depicts exemplary components of a vehicle; and

FIG. 2 depicts a flow diagram of an exemplary method for the operation of a vehicle.

### DETAILED DESCRIPTION OF THE DRAWINGS

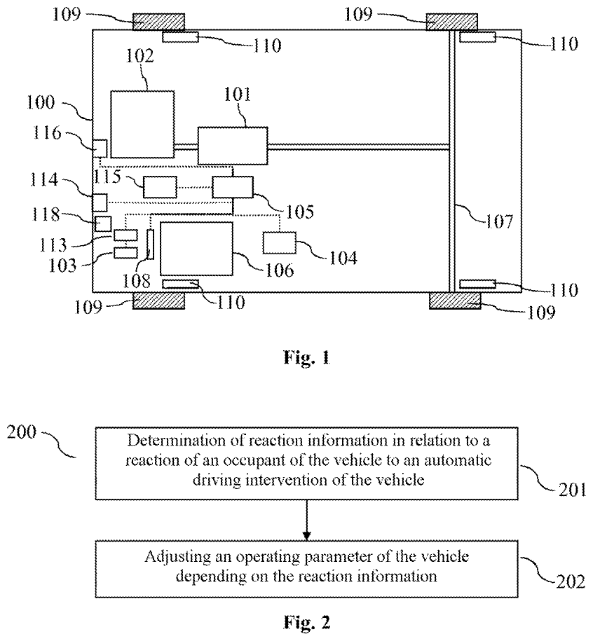

As explained at the outset, this document deals with increasing the confidence and/or safety perception of a user of a vehicle that is at least partially autonomous (in particular a vehicle with SAE level 2, 3 or 4 or higher). In this context, FIG. 1 shows exemplary components of a vehicle 100 (for example of a passenger car, a truck, or a bus). The vehicle 100 comprises a driver's position 106 (as an example of an occupant position or a user position) which can be taken by a driver of the vehicle 100 in order to control the vehicle 100 at least partially. From the driver's position 106, for example, a brake pedal 103 and/or an accelerator pedal 113 (also referred to as the gas pedal) can be operated to decelerate and/or accelerate the vehicle 100. The operation of the brake pedal 103 typically leads to an actuation of wheel brakes (especially friction brakes) 110, which cause a deceleration of the vehicle 100. Furthermore, the vehicle 100 comprises a steering means 108, in particular a steering wheel, with which a steering system 118 of the vehicle 100 can be operated. The brake pedal 103, the accelerator pedal 113 and/or the steering means 108 can be regarded as a controller for the manual longitudinal and/or lateral control of the vehicle 100.

Furthermore, the vehicle 100 comprises a drive motor 102 (for example an internal combustion engine and/or an electric motor) which can drive a wheel axle 107 of the vehicle 100 and thus wheels 109 of the vehicle 100 via a gearbox 101.

The vehicle 100 comprises a control unit 105 (for example as part of a motor control unit). The control unit 105 is set up to receive one or more control signals, for example in relation to a control input by the driver. One or more control signals include, for example, operation of the brake pedal 103 and/or the actuation of the accelerator pedal 113 and/or the actuation of the steering means 108. Furthermore, the control unit 105 of the drive motor 102, the gearbox 101, the clutch 112, the brakes 110 and/or the steering system 118 of the vehicle 100 are designed to control depending on the one or more control signals.

The vehicle 100 may also include a position sensor 104, which is set up to determine position data with respect to a position of the vehicle 100 (for example current GPS coordinates). Furthermore, the vehicle 100 may include one or more environment sensors 116, which are set up to collect environment data that display information regarding an environment of the vehicle 100. The one or more environment sensors 116 may include, for example, one or more cameras, one or more radar sensors, one or more lidar sensors, one or more ultrasonic sensors, etc. The control unit 105 may be set up to control the drive motor 102, the gearbox 101, the clutch 112, the brakes 110 and/or the steering system 108 depending on the position data and/or the environment data. Thus, at least partially autonomous longitudinal and/or lateral control of the vehicle 100 can be caused.

Furthermore, the vehicle 100 may comprise an input/output unit 115. A user of the vehicle 100 can use input means of the input/output unit 115 (for example via a touch-sensitive screen) to generate a setting and/or instruction for the vehicle 100. In addition, a user of the vehicle 100 may receive information and/or instructions regarding the operation of the vehicle 100 via output means (for example via a screen) of the input/output unit 115.

For example, a user of the vehicle 100 can enter a desired end point of a driving route via the input/output unit 115. The control unit 105 of the vehicle 100 can then (for example by means of a navigation application that uses digital map information) determine a driving route from a (current) starting point to the end point. Furthermore, the control unit 115 can be set up to control the vehicle 100 longitudinally and/or laterally (at least partially or highly or fully) automatically along the planned route.

Furthermore, the vehicle 100 may comprise one or more occupant sensors 114 (for example an imaging camera, a pulse rate sensor, etc.) which are set up to capture sensor data relating to an occupant of the vehicle 100, in particular relating to the driver. These sensor data are also referred to in this document as occupant or user data. The control unit 105 may be set up to determine, on the basis of the occupant data, whether the occupant of the vehicle 100 feels comfortable and/or safe while driving or not. The occupant data may indicate for example the face and/or facial expression of a user of the vehicle 100; a direction of view of the user; an object that is being observed by the user; an emotional state of the user; the user's blood pressure; the user's pulse rate; etc.

The control unit 105 of the vehicle 100 can therefore be set up for automatic intervention in the longitudinal and/or lateral control of the vehicle 100 (for example within the framework of a driver assistance system, such as ACC, a lane-keeping assistant, etc., or in the context of highly or fully automated driving of the vehicle 100). An automatic intervention can be carried out depending on one or more operating parameters. Exemplary operating parameters are:

a minimum permissible safety distance of the vehicle 100 from another road user;

a maximum permissible driving speed of the vehicle 100;

a recommended speed of the vehicle 100 at which a vehicle 100 is to be driven on average;

a maximum permissible longitudinal acceleration and/or deceleration of the vehicle 100;

a maximum permissible lateral acceleration of the vehicle 100;

a maximum permissible steering torque and/or a maximum permissible steering angle;

a maximum permissible rate of change of the steering torque and/or steering angle;

a tendency to perform automatic lane changes (for example for overtaking maneuvers);

dynamics for performing lane changes; and/or

a differential speed relative to a vehicle ahead, which must be present at least before a maneuver of overtaking the vehicle ahead is initiated.

For the one or more operating parameters, standard values may be defined, which can be changed manually by an occupant or user of the vehicle 100 via the input/output unit 115 of the vehicle 100. If necessary, different driving modes with different default values can be provided and selected by a user (for example a sporty driving mode, a comfortable driving mode and/or an energy-saving driving mode). However, the manual adjustment of values of one or more operating parameters or the manual selection of different driving modes typically requires a certain basic understanding of how the different operating parameters or driving modes affect the driving style of the vehicle 100. Furthermore, a manual adjustment or adaptation of one or more operating parameters cannot typically ensure that a feeling of safety and/or well-being of a user during at least partially autonomous driving of the vehicle 100 is enhanced. The method 200 described in this document therefore allows the adjustment of one or more operating parameters of a vehicle 100 in an automatic manner (without the need for a manual adjustment of the values of the one or more operating parameters for this purpose).

The control unit 105 may be set up to determine reaction information of an occupant or user, in particular a driver, of the vehicle 100 in relation to an automatic intervention in the longitudinal and/or lateral control of the vehicle 100. The reaction information can indicate whether and, if necessary, how the user of the vehicle 100 has reacted to the automatic intervention of the vehicle 100. Alternatively or in addition, the reaction information can indicate a psychological state of the user.

The reaction information can be determined on the basis of the occupant data. For example, based on image data from a camera, a level of attention of the user and/or a facial expression of the user may be captured and/or determined. Furthermore, for example the pulse rate and/or blood pressure of the user can be determined. In addition, a focal point of the user's attention can be determined during an automatic intervention of the vehicle 100.

Alternatively or in addition, the reaction information can be determined on the basis of an operation of a control means 103, 113, 108 of the vehicle 100 (for example the accelerator pedal 113, the brake pedal 103 and/or the steering means 108). For example, it is possible to determine when and/or how often the user corrects or modifies the automatic intervention of the vehicle 100 (for example by manually operating a control device 103, 108, 113).

The reaction information may, for example, indicate that the user has an increased stress level (especially in response to a specific automatic intervention of the vehicle 100). On the other hand, the reaction information may also indicate that one or more automatic interventions of the vehicle 100 have not caused a particular reaction of the user and/or have not been perceived by the user (as disturbing).

The control unit 105 can be set up to correlate the reaction information with a specific type of intervention. In particular, it can be determined whether the reaction of the user indicated by the reaction information is caused by a specific longitudinal or lateral control intervention. Furthermore, at least one operating parameter of the vehicle 100 can be determined which has an influence on the specific longitudinal or lateral control intervention. For example, it can be determined whether the currently set value of the safety distance and/or the dynamics of the longitudinal and/or lateral control leads to stress reactions of the user during automatic interventions of the vehicle 100. If this is the case, the value of the safety distance and/or dynamics of the longitudinal and/or lateral control may be changed to reduce the stress level of the user.

The value of at least one operating parameter of the vehicle 100 can therefore be adjusted automatically depending on the reaction information. For example, the value of the safety distance can be increased if the reaction information indicates that the user of the vehicle 100 feels uncomfortable with the currently set value of the safety distance. On the other hand, if necessary, a reduction in the value of the safety distance can be caused if the reaction information indicates that the currently set value of the safety distance is not causing a conspicuous reaction of the user.

The control unit 105 may be set up to identify and store a plurality of profiles for a plurality of users of the vehicle 100. The profile of a user can indicate individual values of one or more operating parameters of the vehicle 100 for the user. The individual values can be determined automatically during a journey of the user in the vehicle 100.

The control unit 105 can be set up to determine which user is located in the vehicle 100 for a journey of the vehicle 100. The specific profile of the user can then be selected to operate the vehicle 100 according to the profile of the user. In this way, the driving behavior of a vehicle 100 can be adapted to different users in an efficient manner.

FIG. 2 shows a flow diagram of an exemplary method 200 for the adaptation of a vehicle 100, which is set up to cause automatic intervention in the longitudinal and/or lateral control of the vehicle 100, to a user of the vehicle 100, in particular to the preferences of a user of the vehicle 100. The vehicle 100 may be equipped to perform the longitudinal and/or lateral control of the vehicle 100 at least partially automatically. For example, the vehicle 100 may have one or more driver assistance systems (such as ACC and/or a lane control assistant) that are set up to drive the vehicle 100 semi-automatically. In a preferred example, the vehicle 100 may be set up to drive the vehicle 100 highly automatically or fully automatically.

The method 200 involves the determination 201 of reaction information in relation to a reaction of a user of the vehicle 100 to at least one automatic intervention of the vehicle 100. The reaction information can indicate whether the user of the vehicle 100 feels an increased level of stress or uncertainty or not due to the one or more automatic interventions of the vehicle 100. The reaction information can be determined on the basis of the sensor data of one or more occupant sensors 114. Alternatively or in addition, the reaction information may be based on one or more operations of one or more control means 103, 108, 113 of the vehicle 100 by the user. The control means 103, 108, 113 may include the accelerator pedal 113, the steering means 108 and/or the brake pedal 103, for example.

In addition, the method 200 includes the adaptation 202 of at least one operating parameter of the vehicle 100, which has an influence on automatic interventions in the longitudinal and/or lateral control of the vehicle 100, depending on the reaction information. In particular, one or more operating parameters can be adjusted to adjust (for example to reduce) the level of stress and/or uncertainty of the user indicated by the reaction information to a target level.

As explained above, the vehicle 100 may comprise an input/output unit 115 (also referred to as the user interface). It can be determined on the basis of the reaction information that the value of at least one operating parameter of the vehicle 100 (for example the safety distance from a vehicle ahead) should be changed, in particular in order to adjust the driving behavior or the automatic driving style of the vehicle 100 to the preferences of a user of the vehicle 100 (extracted from the reaction information). The user can then be asked via the user interface 115 whether the value of the operating parameter should be changed or not. Furthermore, a user input of the user in relation to the issued request can be captured at the user interface 115. Furthermore, depending on the user input, a change in the value of the operating parameter may or may not be made. In this way, the comfort and feeling of safety of a user can be further enhanced. In particular, a user can be given the impression that the vehicle 100 is taking care of the well-being of the user automatically.

Alternatively or in addition to changing an operating parameter of the vehicle 100, which is at least partially autonomous, depending on the reaction information an automated driving maneuver can be performed automatically. For example, the reaction information may indicate that the user of the vehicle 100 feels uncomfortable in a current situation of the vehicle 100 (for example driving next to a truck). A driving maneuver can then be carried out automatically (for example an acceleration or a deceleration of the vehicle 100 and/or an overtaking maneuver) to change the current situation of the vehicle 100 (for example to move away from the truck). By automatically performing a suitable driving maneuver, the comfort and feeling of safety of a user of a vehicle 100 can be increased in an efficient manner.

As explained above, the reaction information may include or indicate the operation of a control means 103, 108, 113 of the vehicle 100 by a user. On the basis of a plurality of operations of the control means 103, 108, 113, a statistical evaluation of the manual interventions of the user can be carried out. In particular, a statistical evaluation may be carried out on how frequently and/or in what way a particular automatic intervention of the vehicle 100 has been modified by a manual intervention of the user. In an analogous way, a statistical evaluation of a detected stress level of the user can be carried out. The statistical analysis can then be used to set a value of at least one operating parameter and/or the driving style of the vehicle 100.

For example, it can be determined that a user performs a corrective manual intervention in x% of the cases of automatic intervention. Alternatively or in addition, it can be determined that a user has an increased stress level (for example a stress level above a certain reference stress level) in y% of the cases of an automatic intervention. If x and/or y is at or above a certain frequency threshold, a change of at least one operating parameter may be made to ensure that the frequency of manual corrective interventions and/or the frequency of increased stress levels is reduced (if possible to 0%).

The measures described in this document make it possible to control the driving behavior of a vehicle 100 which is at least partially autonomous efficiently and precisely to the preferences of a user of the vehicle 100. This can increase the comfort and feeling of safety of a user.

The embodiments of the present invention are not limited to the exemplary embodiments indicated. In particular, it should be noted that the description and the figures are intended to illustrate only the principle of the proposed methods, devices, and systems.

1.-10. (canceled)

11. An apparatus comprising:
a control unit for a vehicle that is equipped to cause automatic interventions in the longitudinal and/or lateral control of the vehicle wherein the control unit is configured to:
determine reaction information relating to a reaction of a user of the vehicle to at least one automatic intervention of the vehicle; and
adjust least one operating parameter of the vehicle, which has an influence on automatic interventions in the longitudinal and/or lateral control of the vehicle, depending on the reaction information.

12. The apparatus according to claim 11, wherein
the control unit is also configured to determine sensor data relating to the user of the vehicle;
the sensor data indicate a head and/or face of the user and/or a body-related measurement variable of the user; and
the reaction information is determined based on the sensor data in relation to the user of the vehicle.

13. The apparatus according to claim 12, wherein
the vehicle comprises one or more control means which enable the user to exert an effect on the longitudinal and/or lateral control of the vehicle by operating the one or more control means;
the control unit is configured to detect an operation of the one or more control means, via which a change is caused that pertains to an effect of an automatic intervention of the vehicle on the vehicle; and
the reaction information indicates the change in the effect on the vehicle caused by the operation of the control means.

14. The apparatus according to claim 13, wherein the change in the effect on the vehicle includes:
a change in the distance between the vehicle and another road user;
a change in the time of an intervention in the lateral and/or longitudinal control of the vehicle;
a change in a longitudinal acceleration and/or deceleration of the vehicle;
a change in a steering angle and/or steering torque on a steering wheel of the vehicle;
a change in the dynamics of the vehicle when changing lanes; and/or
a cancellation of a lane change.

15. The apparatus according to claim 14, wherein the control unit is also configured to:
determine, on the basis of the reaction information, that automatic longitudinal and/or lateral control of the vehicle caused by one or more automatic interventions of the vehicle causes stress and/or uncertainty to the user; and
change a value of the at least one operating parameter of the vehicle in order to reduce the dynamics of the automatic longitudinal and/or lateral control of the vehicle and/or to increase one or more safety distances to be observed during the automatic longitudinal and/or lateral control of the vehicle.

16. The apparatus according to claim 15, wherein the control unit is also configured to:
determine on the basis of the reaction information that automatic longitudinal and/or lateral control of the vehicle caused by one or more automatic interventions of the vehicle does not cause stress and/or uncertainty to the user; and
change a value of the at least one operating parameter of the vehicle in order to increase the dynamics of the automatic longitudinal and/or lateral control of the vehicle and/or to reduce one or more safety distances to be observed during the automatic longitudinal and/or lateral control of the vehicle.

17. The apparatus according to claim 16, wherein the at least one operating parameter includes:
a minimum permissible safety distance of the vehicle from another road user;
a maximum permissible driving speed of the vehicle;
a recommended speed of the vehicle, at which the vehicle should be driven on average;
a maximum permissible longitudinal acceleration and/or deceleration of the vehicle;
a maximum permissible lateral acceleration of the vehicle;
a maximum permissible steering torque and/or a maximum permissible steering angle on a steering system of the vehicle;
a maximum permissible speed change or a maximum permissible gradient against time of the steering torque and/or the steering angle on the steering system of the vehicle;
a tendency of the vehicle to perform automatic lane changes on a multi-lane road; and/or
dynamics when performing a lane change.

18. The apparatus according to claim 17, wherein the control unit is also configured to:
for a plurality of different users of the vehicle, determine a corresponding plurality of user-specific values for the at least one operating parameter and to store it in a corresponding plurality of user profiles;
for a journey of the vehicle, determine the user from the plurality of different users who use the vehicle; and
cause automatic interventions in the longitudinal and/or lateral control of the vehicle in accordance with the user profile of the identified user when the vehicle is travelling.

19. The apparatus according to claim 18, wherein
the control unit is also configured to determine a driving behavior preferred by the user on the basis of the reaction information;
the driving behavior preferred by the user indicates:
a lane preferred by the user in a construction site area; and/or
that the user is reluctant to drive alongside a truck or bus in heavy traffic; and
the control unit is also configured to perform automatic interventions in the longitudinal and/or lateral control of the vehicle in order to implement the driving behavior preferred by the user.

20. A method for adaptation of a vehicle, comprising:
determining reaction information in relation to a reaction of a user of the vehicle to at least one automatic intervention of the vehicle, wherein
the adaptation is configured to perform automatic interventions in the longitudinal and/or lateral control of the vehicle, to a user of the vehicle; and
adapting at least one operating parameter of the vehicle, which has an influence on automatic interventions in the longitudinal and/or lateral control of the vehicle, depending on the reaction information.
